(19) United States
(12) Patent Application Publication
(10) Pub. No.: US 2025/0344116 A1
(43) Pub. Date: Nov. 6, 2025

(54) SYSTEM AND METHOD FOR IDENTIFICATION OF HIGH RANK NEIGHBOR CELLS

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Rajeshwari VENKATRAMAN, Bangalore (IN); Pratik KAPADIYA, Navi Mumbai (IN); Abhishek SHARMA, Indore (IN); Aishwary JAIN, Navi Mumbai (IN)

(73) Assignee: JIO PLATFORMS LIMITED, Ahmedabad (IN)

(21) Appl. No.: 18/993,099

(22) PCT Filed: May 30, 2024
(86) PCT No.: PCT/IN2024/050650

§ 371 Date: Jan. 10, 2025

(30) Foreign Application Priority Data
Jun. 29, 2023 (IN) 202321043759

(51) Int. Cl. H04W 36/00; H04B 17/309; H04B 17/318; H04L 41/5009

(52) U.S. Cl. CPC H04W 36/00835; H04B 17/328; H04B 17/346; H04L 41/5009

(57) ABSTRACT

The system (100-2) and method for identification of high ranked neighbor cells in a telecommunications network provide an efficient and accurate approach to selecting neighboring cells with superior performance for handover purposes. The system (100-2) leverages performance metrics, algorithms, and dynamic adaptation techniques to determine the suitability and ranking of potential neighbor cells. By considering factors such as signal strength, signal quality, interference levels, load balancing requirements, and operator-defined policies, the system (100-2) evaluates the performance of neighbor cells and assigns them scores or rankings to identify the higher ranked neighbor cells. The system's dynamic adaptation ensures that the rankings remain up to date and responsive to changing network conditions. The present system (100-2) and method optimize handover decisions, enhance network performance, and provide users with seamless connectivity and improved quality of service.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to the field of telecommunications and network management. More precisely, it relates to a system for the identification of high-ranking neighbor cells for handing over the user's connection from the present serving cell to the neighbor cell.

### DEFINITION

As used in the present disclosure, the following terms are generally intended to have the meaning as set forth below, except to the extent that the context in which they are used to indicate otherwise.

The expression ‘handover” used hereinafter in the specification refers to a process of transferring an ongoing communication session (such as a call or data session) from one base station (eNodeB) to another as a user moves between coverage areas. This process is crucial for maintaining seamless connectivity and ensuring quality of service as users move within the network.

The expression ‘handover share’ used hereinafter in the specification refers to an allocation or distribution of resources, such as spectrum or bandwidth, among different network nodes (base stations or gNBs—gNodeBs). This allocation determines how much capacity each node has for handling handover procedures and ensuring smooth transitions for users moving between cells.

These definitions are in addition to those expressed in the art.

### BACKGROUND

Background description includes information that may be useful in understanding the present invention. It is not an admission that any of the information provided herein is prior art or relevant to the presently claimed invention, or that any publication specifically or implicitly referenced is prior art.

Whenever a mobile device moves from one cell to another, the network needs to identify the most suitable neighboring cell for handover to maintain a stable connection and deliver a high-quality user experience. Cellular networks are composed of a grid of cells, each served by a base station or cell tower. These cells collectively provide coverage to a specific geographical area. When a mobile device moves from one cell to another, it needs to connect to a neighboring cell with a stronger signal and better service quality. Handover is the process of transferring an ongoing call or data session from one cell to another. It is initiated when the signal strength of the serving cell weakens below a certain threshold or when a neighboring cell provides a stronger signal. Handover aims to ensure uninterrupted service and minimize call drops or data interruptions during the transition.

To identify high-ranking neighbor cells, the network collects measurements from both the serving cell and neighboring cells. These measurements include signal strength, signal quality, interference levels, cell load, available capacity, and other performance metrics. These measurements help assess the quality and suitability of neighboring cells for handover. Various algorithms and techniques are used to evaluate the collected measurements and determine the ranking or priority of neighboring cells. These algorithms may consider factors such as signal strength, signal-to-interference ratio (SIR), quality of service requirements, cell load balancing, and network policies. Machine learning techniques can also be employed to improve the accuracy of handover decisions. The identification of high-ranking neighbor cells plays a crucial role in network optimization. By selecting the most suitable neighboring cells for handover, the network can improve signal coverage, minimize call drops, balance network traffic, and enhance overall network performance and capacity.

The identification of high-ranking neighbor cells involves understanding the principles of handover, the collection of network measurements, the utilization of decision algorithms, and the overall goal of network optimization. By effectively identifying and selecting high ranking neighbor cells, telecommunications systems can ensure seamless handovers, provide better coverage and service quality to mobile devices, and deliver an enhanced user experience.

Existing systems for the identification of high-ranking neighbor cells in telecommunications networks vary depending on the specific technology and network infrastructure. The Received Signal Strength (RSS) Based Systems determine the quality of neighboring cells based on their received signal strength. The system selects the neighbor cell with the strongest signal as the high-ranking neighbor cell. However, this approach has drawbacks as it may not consider other important factors such as interference, signal quality, or network load, which can impact the overall performance and suitability of the neighbor cell. The Signal-to-Interference Ratio (SIR) Based Systems evaluate the SIR of neighboring cells to identify high ranking neighbor cells. Higher SIR indicates better signal quality and lower interference. However, SIR-based systems may not account for other crucial factors such as cell load, traffic conditions, or specific quality of service requirements, which can affect the selection of an optimal neighbor cell.

There is, therefore, a need to overcome the above drawbacks and limitations in the current practices to provide an optimal solution for identifying neighbor cells with a high rank to transfer the user's connection. The system in the present disclosure aims to leverage a combination of parameters, employ intelligent algorithms, and consider real-time network conditions to accurately identify high ranking neighbor cells for optimal handover decisions.

### SUMMARY

The present disclosure discloses a method for identifying one or more high rank neighbor cells in a network. The method includes collecting, by an aggregation module, data corresponding to a plurality of parameters related to a plurality of neighboring cells from an element management system (EMS). The method includes computing, by a performance module, one or more key performance indicators (KPIs) for the plurality of neighbor cells based on the data aggregated corresponding to each of the plurality of parameters over a first predetermined time period. The method includes computing, by the performance module, a plurality of KPIs for a plurality of source-target pairs. Each source-target pair comprises a source cell and a target cell for handover. The method includes computing, by the performance module, a total handover (HO) attempts over one or more interfaces for a second predefined period for each source-target pair in a service area, wherein each interface is a connection point between the source cell and the target cell. The method includes calculate, by the performance module, a percentage of HO share contributed by each source-target pair, wherein the percentage of HO share contributed by each source-target pair is based upon a number of HO attempts per source-target pair. The method includes identifying, by a source-target module, one or more source-target pairs having the percentage of HO share greater than a defined threshold. The method includes identifying, by the source-target module, the one or more high rank neighbor cells by ranking, the identified source-target pairs having the percentage of HO share greater than the defined threshold and generating a list of the high ranked neighbor cells associated with each source cell.

In an aspect, the percentage of HO share={100*[(total number of HO attempts per source-target pair)/(total number of HO attempts for all interfaces for the source cell)]}.

In an aspect, the plurality of parameters comprises one or more of a signal strength, a signal quality, a plurality of interference levels, a data throughput, call drop rates, a latency, and a capacity of the neighboring cell.

In an aspect, the first predefined time lies in a range of 15 to 30 minutes, and the second predefined time lies in a range of one hour to two hours.

In an aspect, the method further includes a step of arranging, by the source-target module, the plurality of source-target pairs in a descending order based on the percentage HO share.

In an aspect, the plurality of KPIs include one or more of signal strength, signal quality, a plurality of interference levels, load balancing requirements, a coverage area, a capacity, and a plurality of operator-defined policies.

In an aspect, the method further includes a step of storing, by a database, the generated list of high ranked neighbor cells associated with each of the source cells.

In an aspect, the method further includes a step of analysing the one or more high ranked neighbor cells associated with each source cell to enable handover planning, cell compensation, and capacity planning.

The present disclosure discloses a system for identifying one or more high rank neighbor cells in a network. The system includes an aggregation module, a performance module, and a source-target module. The aggregation module is configured to collect data corresponding to a plurality of parameters related to a plurality of neighboring cells from an element management system (EMS). The performance module is configured to compute one or more key performance indicators (KPIs) for the plurality of neighbor cells based on the data aggregated corresponding to each of the plurality of parameters over a first predetermined time period. The performance module is configured to compute a plurality of KPIs for a plurality of source-target pairs, wherein each source-target pair comprises a source cell and a target cell for handover. The performance module is configured to compute a total handover (HO) attempts towards over one or more interfaces for a second predefined period for each source-target pair in the service area, wherein the interface is a connection point between the source cell and the target cell. The performance module is configured to calculate a percentage of HO share contributed by each source-target pair, wherein the percentage of HO share contributed by each source-target pair is based upon a number of HO attempts per source-target pair. The source-target module is configured to identify one or more source-target pairs having the percentage of HO share greater than a defined threshold. The source-target module is configured to identify the one or more high rank neighbor cells by ranking the identified source-target pairs having the percentage of HO share greater than the defined threshold and generate a list of the high ranked neighbor cells associated with each source cell.

In an embodiment, the percentage of HO share={100*[(total number of HO attempts per source-target pair)/(total number of HO attempts for all interfaces for the source cell)]}.

In an embodiment, the plurality of parameters comprises one or more of a signal strength, a signal quality, a plurality of interference levels, a data throughput, call drop rates, a latency, and a capacity of the neighboring cells.

In an embodiment, the first predefined time lies in a range of 15 to 30 minutes, and the second predefined time lies in a range of one hour to two hours.

In an embodiment, the source-target module is configured to rank the plurality of source-target pairs in descending order on basis of the percentage share of HO attempts.

In an embodiment, the plurality of KPIs include one or more of signal strength, signal quality, a plurality of interference levels, load balancing requirements, a coverage area, a capacity, and a plurality of operator-defined policies.

In an embodiment, the system includes a database (218) configured to store the generated list of high ranked neighbor cells associated with each of the source cells.

In an embodiment, the system is further configured to analyse the one or more high ranked neighbor cells associated with each source cell to enable handover planning, cell compensation, and capacity planning.

The present disclosure further discloses a user equipment which is configured to identify one or more high rank neighbor cells in a network. The user equipment includes a processor, and a computer readable storage medium storing programming instructions for execution by the processor. Under the programming instructions, the processor is configured to collect data corresponding to a plurality of parameters related to a plurality of neighboring cells from an element management system (EMS). Under the programming instructions, the processor is configured to compute one or more key performance indicators (KPIs) for the plurality of neighbor cells based on the data aggregated corresponding to each of the plurality of parameters over a first predetermined time period. Under the programming instructions, the processor is configured to compute a plurality of KPIs for a plurality of source-target pairs, wherein each source-target pair comprises a source cell and a target cell for handover. Under the programming instructions, the processor is configured to compute a total handover (HO) attempts over one or more interfaces for a second predefined period for each source-target pair in a service area, wherein each interface is a connection point between the source cell and the target cell. Under the programming instructions, the processor is configured to calculate a percentage of HO share contributed by each source-target pair, wherein the percentage of HO share contributed by each source-target pair is based upon a number of HO attempts per source-target pair. Under the programming instructions, the processor is configured to identify one or more source-target pairs having the percentage of HO share greater than a defined threshold. Under the programming instructions, the processor is configured to identify the one or more high rank neighbor cells by ranking, the identified source-target pairs having the percentage of HO share greater than the defined threshold and generate a list of the high ranked neighbor cells associated with each source cell.

### OBJECTS OF INVENTION

Some of the objects of the present disclosure, that at least one embodiment herein satisfy are as listed herein below.

It is an object of the present disclosure to overcome the drawbacks and limitations of the existing systems to identify a high-ranking cell to handover a user's connection.

It is an object of the present disclosure to accurately identify high ranking neighbor cells, minimize call drops, reduce interruption in data sessions, and ensure seamless handover transitions for mobile devices.

It is an object of the present disclosure to help maintain stronger and more reliable connections, leading to improved voice call clarity, faster data speeds, and a better user experience.

It is an object of the present disclosure to distribute user traffic evenly among neighboring cells, optimizing the utilization of network resources and improving overall network capacity.

It is an object of the present disclosure to minimize the degradation of signal quality and ensure a more stable and consistent connection for mobile devices.

It is an object of the present disclosure to continuously monitors network parameters, such as signal strength, signal quality, interference levels, and cell load, to identify the most suitable high ranking neighbor cells based on the prevailing conditions.

It is an object of the present disclosure to consider parameters and thresholds set by the operators to prioritize certain neighbor cells over others, aligning with the operator's network management objectives and ensuring compliance with service level agreements.

It is an object of the present disclosure to improve the user experience and satisfaction by providing seamless handover experiences, reliable connections, and consistent service quality.

### BRIEF DESCRIPTION OF DRAWINGS

The specifications of the present disclosure are accompanied with drawings of the system and method to aid in better understanding of the said invention. The drawings are in no way limitations of the present disclosure, rather are meant to illustrate the ideal embodiments of the said disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates a network architecture of a system for identifying one or more high rank neighbor cells in a network, in accordance with an embodiment of the present invention.

FIG. 1B illustrates steps taken by the system for identification of high ranked neighbor cells, in accordance with an embodiment of the present disclosure.

FIG. 2 illustrates an exemplary block diagram of the system, in accordance with an embodiment of the present disclosure.

FIG. 3 illustrates an exemplary flow diagram of an identification of high rank neighbor cells, in accordance with an embodiment of the present disclosure.

FIG. 4 illustrates an exemplary computer system in which or with which embodiments of the present invention can be utilized, in accordance with an embodiment of present disclosure.

FIG. 5 illustrates exemplary steps of a method identifying one or more high rank neighbor cells in a network, in accordance with embodiments of the present disclosure.

### LIST OF REFERENCE NUMERALS

100-1—Network Architecture
102—Network
104—Controller
106-1, 106-2 . . . 106-8—Plurality of Base Stations
100-2—System
202—One or more processor(s)
204—Memory
206—A Plurality of Interfaces
208—Processing Engine
210—Performance Module
212—Aggregation Module
214—Source Target Module
216—Other Module(s)
218—Database
410—External Storage Device
420—Bus
430—Main Memory
440—Read Only Memory
450—Mass Storage Device
460—Communication Port
470—Processor

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

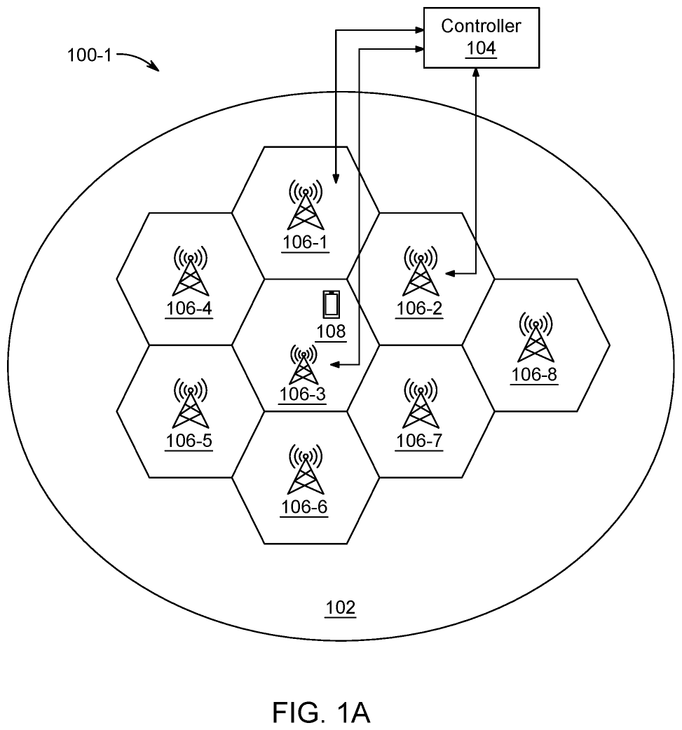

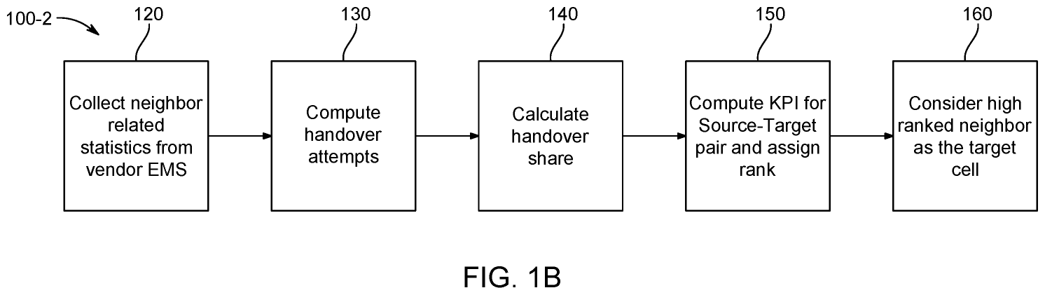

The various embodiments throughout the disclosure will be explained in more detail with reference to FIGS. 1-5.

The present disclosure relates to the field of telecommunications and network management. More precisely, it relates to a system for the identification of high-ranking neighbor cells for handing over the user's connection from the present serving cell to the neighbor cell.

FIG. 1A illustrates a network architecture (100-1) of a system for identifying one or more high rank neighbor cells in a network, in accordance with an embodiment of the present invention.

The network architecture (100-1) comprises a controller (104), a plurality of base stations (106-1, 106-2, 106-3, 106-4 . . . 106-N) and at least one user equipment (108) in a network (102). The controller (104) may be a system for identification of high ranked neighbor cells in the network (102). The plurality of base station may be communicatively coupled to the user equipment (108). The plurality of base station is communicatively coupled to the controller (104).

FIG. 1B illustrates a block diagram for identification of high ranked neighbor cells, in accordance with an embodiment of the present disclosure.

As illustrated, in FIG. 1B, a block diagram of the system (100-2) for identification of high ranked neighbors is disclosed.

At step (120), the system (100-2) in the present disclosure collects neighbor related statistics from vendor element management system (EMS). The neighbor related statistics may include raw performance management counter data. The neighbor related statistics comprises a signal strength, a signal quality, a plurality of interference levels, a data throughput, call drop rates, a latency, and a capacity.

At step (130), the system (100-2) in the present disclosure finds the list of potential neighbor for all the cells on rolling weekly basis. The total handover attempts towards all the interfaces over a rolling period of 7 days is counted for all the cells in the service area. Similarly, total handover attempts towards all the interfaces over a rolling period of 7 days is counted for each of the unique source-target pair. The percentage of contribution of attempts of each source-target pair in overall Handover attempts is also computed.

At step (140), the handover share is computed as total HO attempts per source-target pair to total HO attempts for each cell. The percentage of contribution/share of attempts of each source-target pair in overall Handover attempts is also computed.

At step (150), the source-target pairs are arranged in descending order basis of a percentage share of handover attempts. Any source-target pair having more than 10% (value is configurable) of a handover share is identified as a high ranked neighbor. The system (100-2) computes key performance indictors (KPIs) for source-target pair and assigns rank. The KPIs comprises signal strength, signal quality, a plurality of interference levels, load balancing requirements, a coverage area, a capacity, and a plurality of operator-defined policies.

At step (160), the high ranked neighbors are identified with these features which are used in other algorithms like capacity planning and also for cell compensation for mitigating the cell outage. The high ranked neighbor cells state helps the operations team to identify the cause for the performance degradation of the other cells.

In an embodiment, in a typical telecom network, as represented in the system (100-2) in the present disclosure, maintaining service continuity and good customer experience is of prime importance. Providing good customer experience in case of mobility scenario is a challenging task as the end user is not static. In such a scenario, the user can be latched initially to one of the telecom nodes and during the ongoing call/data session it might happen that the user's connection is handed over from the present serving cell to the neighbor cell. To ensure a seamless experience it becomes essential to have proper handover related definitions between the adjacent nodes and all the neighbor definitions which are properly audited and optimized parameter settings are in place. With the introduction of self-optimization feature in next generation networks (5G/6G), the system (100-2) adds the neighbors automatically based on certain pre-defined criteria. Generally, one cell can have to the tune of number of neighbor cells and the number of neighbor cells may vary from case to case depending upon the Handover scenario. In such a case, it is essential to identify the high ranked neighbor which are required for capacity planning of the network. In the case of cell outage to improve the customer experience, cell compensation is done by optimizing the high ranked neighbors. Moreover, in most of the cases each of the source cell will be having very few potential neighbors which will be contributing to 90-95 percentage of overall handover attempts.

In an embodiment, the optimal strategy for identifying high ranked neighbor cells in a telecommunications network may vary depending on network-specific requirements and conditions. The system (100-2) chooses relevant performance metrics that accurately reflect the quality and suitability of neighbor cells. These metrics can include signal strength, signal quality, interference levels, data throughput, call drop rates, latency, and capacity. The system (100) assigns appropriate weights to performance metrics based on their significance in determining the ranking of neighbor cells. It also sets threshold values for each metric to define the desired performance level for high ranked neighbors and fine-tunes the weights and thresholds based on network-specific requirements and quality of service (QoS) targets. The system (100-2) can include weighted averaging, fuzzy logic, machine learning, or other statistical methods. Consider algorithms that can effectively handle large datasets, adapt to changing network conditions, and provide accurate rankings based on the chosen metrics. The system (100-2) is designed to adapt dynamically to real-time network changes and continuously monitor and update the performance metrics and rankings based on the latest data.

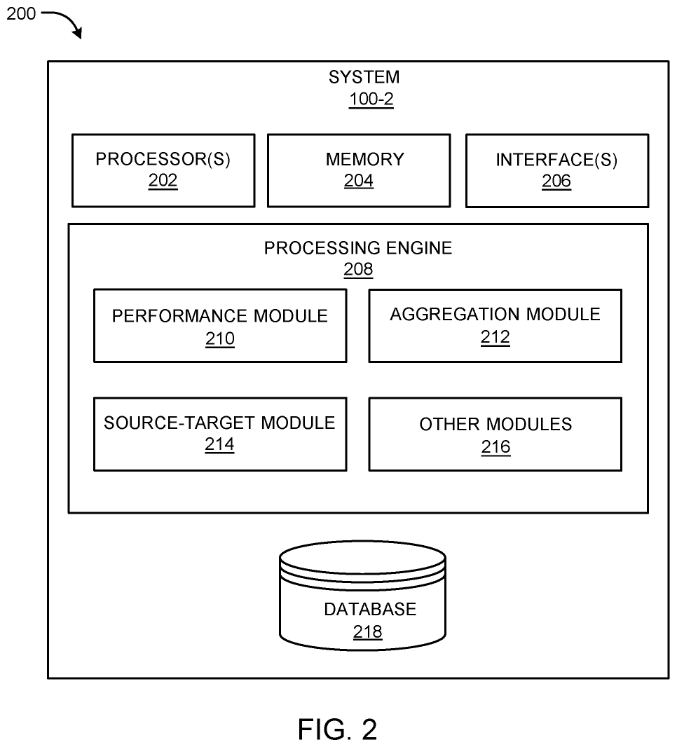

FIG. 2 illustrates an exemplary block diagram of the system (100-2), in accordance with an embodiment of the present disclosure.

As illustrated, in FIG. 2, an exemplary block diagram (200) of the processing engine (208) and all its modules is disclosed. The processing engine (208) for high ranked neighbor identification in telecommunications network typically involves the use of advanced algorithms and computational techniques. The processor (202), memory (204), and interface (206) are used for execution of programming instructions. The processing engine (208) analyses collected data, applies algorithms, and performs calculations to determine the ranking of neighbor cells and the database (218) stores all data. The processing engine (208) collects relevant network measurements and parameters from the serving cell and neighboring cells. This data includes signal strength, signal quality, interference levels, cell load, available capacity, and other performance metrics. The collected data is pre-processed to ensure consistency, accuracy, and compatibility for further analysis. The designated modules and the other executing modules (216) are used for an execution of identification of high ranked cells.

The performance module is configured to compute one or more key performance indicators (KPIs) for the plurality of neighbor cells based on the data aggregated corresponding to each of the plurality of parameters over a first predetermined time period. In an example, the plurality of parameters comprises one or more of a signal strength, a signal quality, a plurality of interference levels, a data throughput, call drop rates, a latency, and a capacity of the neighboring cells. In an example, the first predefined time lies in a range of 15 to 30 minutes. The performance module is configured to compute a plurality of KPIs for a plurality of source-target pairs. Each source-target pair comprises a source cell and a target cell for handover. The performance module is configured to compute a total handover (HO) attempts towards over one or more interfaces for a second predefined period for each source-target pair in the service area. The interface is a connection point between the source cell and the target cell. In an example, the second predefined time lies in a range of one hour to two hours. The performance module is configured to calculate a percentage of HO share contributed by each source-target pair, wherein the percentage of HO share contributed by each source-target pair is based upon a number of HO attempts per source-target pair. The percentage of HO share is defined as {100*[(total number of HO attempts per source-target pair)/(total number of HO attempts for all interfaces for the source cell)]}.

In an embodiment, a performance module (210) is used for the identification of high ranked neighbor cells in a telecommunications network and is responsible for evaluating the performance metrics and determining the suitability of neighboring cells for handover. It involves analysing various performance indicators and applying algorithms to assess the quality and ranking of neighbor cells. The performance module (210) collects and analyses performance metrics related to neighboring cells, such as signal strength, signal quality, interference levels, data throughput, call drop rates, latency, and other relevant parameters. These metrics are used to evaluate the performance of neighbor cells and determine their ranking. The performance module (210) sets threshold values for performance metrics based on network operator policies, quality of service (QoS) requirements, and industry standards. These thresholds define the acceptable levels of performance for high ranked neighbor cells. Metrics that fall within or exceed the defined thresholds are considered favourable for handover. The performance module (210) evaluates the collected metrics against the predefined thresholds and algorithmic rules. It assesses the performance of each neighbor cell and assigns scores or rankings based on their compliance with the performance criteria. The neighbor cells that exhibit superior performance characteristics are assigned high rankings.

In an embodiment, an aggregation module (212) can be used to consolidate and analyse data from multiple sources to determine the overall ranking. The aggregation module is configured to collect data corresponding to a plurality of parameters related to a plurality of neighboring cells from an element management system (EMS). The aggregation module (212) collects relevant data from various sources, such as network measurement databases, performance monitoring systems, network management systems, and other data repositories. This data includes performance metrics, signal strength, signal quality, interference levels, load information, and other parameters related to neighbor cells. It also integrates the collected data from different sources and consolidates it into a unified dataset. This integration process ensures that all relevant data points are considered in the analysis. The aggregation module (212) may also perform data cleansing and normalization to ensure consistency and accuracy. The aggregation module (212) assigns weights to different performance metrics or parameters based on their significance in determining the ranking of neighbor cells. For example, signal quality may be given higher weightage compared to signal strength or interference levels. The aggregation module (212) applies an aggregation algorithm to combine the weighted performance metrics and parameters for each neighbor cell. This algorithm calculates an aggregated score or rank based on the weighted values. Various aggregation techniques can be used, such as weighted averages, weighted sums, or more advanced methods like multi-criteria decision-making algorithms.

In an embodiment, the aggregation module (212) also calculates the rankings of neighbor cells. Cells with higher aggregated scores are assigned higher rankings, indicating their suitability as high ranked neighbors. The ranking calculation process may involve normalization of scores to ensure fair comparison across different metrics. The aggregation module (212) is designed to adapt to dynamic network conditions and changing data. It continuously updates the aggregated scores and rankings based on real-time data updates. This ensures that the rankings remain up to date and reflective of the current network performance. The aggregation module (212) integrates with the handover decision process, providing the ranking information to the handover control system (100-2) or network management systems. This enables the selection of high ranked neighbor cells for handover decisions, considering the aggregated scores and rankings. The aggregation module (212) plays a critical role in consolidating and analysing data from multiple sources to determine the overall ranking of neighbor cells. By considering various performance metrics and applying appropriate aggregation techniques, it provides a comprehensive evaluation of neighbor cell suitability for handover, enabling the selection of higher ranked neighbors for improved network performance and user experience.

In an embodiment, a source-target module (214) is used for determining the potential neighbor cell candidates that have a high ranking compared to the serving cell. The source-target module is configured to identify one or more source-target pairs having the percentage of HO share greater than a defined threshold. The source-target module is configured to identify the one or more high rank neighbor cells by ranking the identified source-target pairs having the percentage of HO share greater than the defined threshold and generate a list of the high ranked neighbor cells associated with each source cell. It analyses the relationship between the serving cell and potential neighbor cells based on various criteria to identify high ranked neighbors. It evaluates the performance and characteristics of the serving cell, including signal strength, signal quality, interference levels, load, capacity, and other relevant parameters. This evaluation serves as a reference point for comparing potential neighbor cells. The source-target module (214) assesses the performance and suitability of potential neighbor cells based on various criteria. These criteria may include signal strength, signal quality, interference levels, load balancing requirements, coverage area, capacity, and operator-defined policies. The source-target module (214) also compares the ranking or scores of potential neighbor cells with that of the serving cell. It identifies the neighbor cells that have a higher ranking or score, indicating their potential to provide better performance or coverage compared to the serving cell. It provides the ranking information to the handover decision process or network management systems. Based on the ranking results, the handover decision process can select the higher ranked neighbor cell as the target for handover, considering other factors such as handover policies, QoS requirements, and network conditions. The source-target module (214) adapts dynamically to changing network conditions and real-time updates. It continuously evaluates the performance of neighbor cells and updates the rankings based on the latest measurements. This ensures that the identification of higher ranked neighbors remains accurate and responsive to the dynamic nature of the network. The source-target module is configured to rank the plurality of source-target pairs in descending order on basis of the percentage share of HO attempts.

In an embodiment, the system is further configured to analyse the one or more high ranked neighbor cells associated with each source cell to enable handover planning, cell compensation, and capacity planning.

In an aspect of the present invention, the controller (104) is configured as the system (100-2) for high ranked neighbor cells identification in telecommunications network.

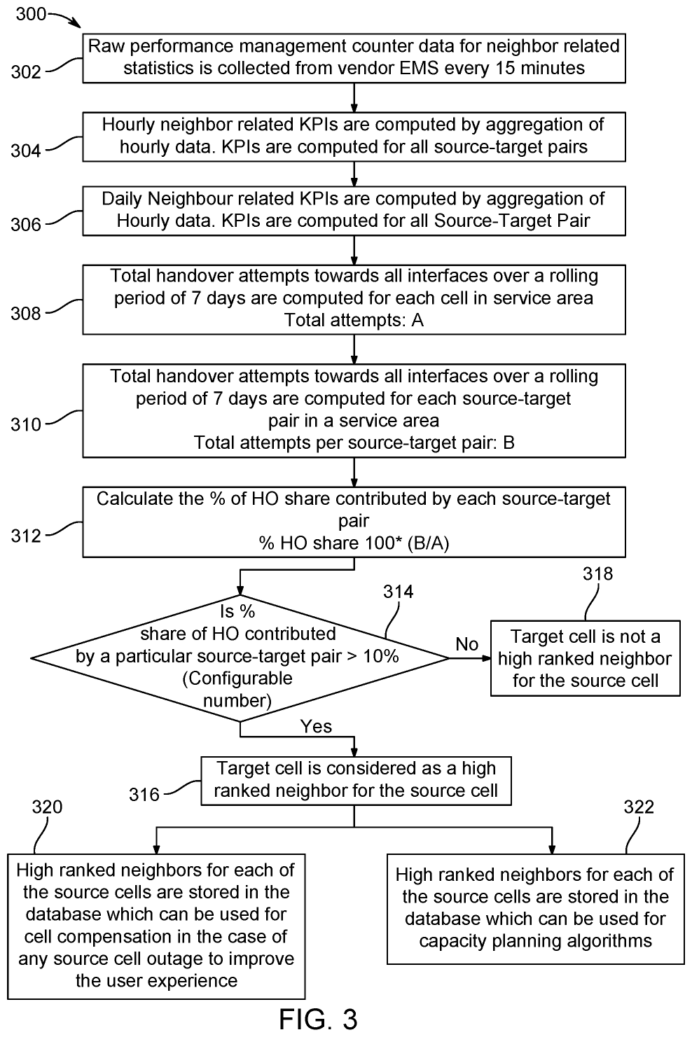

FIG. 3 illustrates an exemplary flow diagram (300) of an identification of high ranked neighbor cells, in accordance with an embodiment of the present disclosure.

As illustrated, in FIG. 3, an exemplary flow diagram (300) for the identification of high ranked neighbor cells is disclosed.

At step (302), the system (100-2) collects relevant measurements from the serving cell and neighboring cells. These measurements include signal strength, signal quality, interference levels, cell load, available capacity, and other performance metrics. The system (100-2) may also consider historical data and trends to supplement the real-time measurements. All the parameters and statistics are extracted from a Vendor Element Management System (EMS) for predefined time (e.g., every fifteen minutes).

At step (304), based on the collected measurements, the system (100-2) calculates various parameters that indicate the quality and suitability of neighbor cells. These parameters may include signal-to-interference ratio (SIR), signal-to-noise ratio (SNR), received power levels, cell load ratio, and other derived metrics that reflect the performance of neighboring cells. The KPIs related to the neighbor cells are computed by aggregation each hour. The system (100-2) assigns appropriate weights to the calculated parameters based on their significance and impact on the handover decision. The weights reflect the relative importance of each parameter in determining the ranking of neighbor cells. Additionally, the system (100-2) sets threshold values for each parameter to define the desired quality or performance level for a high-ranking neighbor cell. KPIs are also calculated for the source-target pair which includes the source or the current cell and the highest ranked neighboring cell.

As illustrated, in FIG. 3, at step (306), the system (100-2) computes daily neighbor related KPIs by aggregation of hourly data. KPIs are computed for all source-target pair.

At step (308), the total handover (HO) attempts towards all the interfaces over a rolling period of 7 days are computed for each cell in service area. Total HO attempts for each cell=A.

At step (310), the total handover (HO) attempts towards all the interfaces over a rolling period of 7 days are computed for every source-target pair in a given service area. Total HO attempts per source-target pair=B.

At step (312), the handover share is computed as total HO attempts per source-target pair to total HO attempts for each cell. The percentage of handover shares contributed by each target-source pair is calculated. The formula is given by: percentage HO share={100*[(total HO attempts per Source-Target pair (B))/(total HO attempts for each cell (A))]}.

At step (314), determining whether percentage share of HO contributed by a particular source-target pair>configurable number/certain threshold (e.g., 10 percentage).

At step (316), if the calculated percentage is higher than a certain threshold then the target cell is considered as a high ranked neighbor for the source cell.

At step (318), if the calculated percentage is not higher than a certain threshold then the target cell is not considered as a high ranked neighbor for the source cell.

At step (320), all the high ranked neighbors are stored in for each source cell is stored in the database (218). This can be used for a cell compensation in the case of any source cell outage to improve a user experience.

At step (322), all the high ranked neighbors are stored in for each source cell is stored in the database (218). The high ranked neighbors can also be used for capacity planning algorithms. This implementation will filter the potential neighbor relations for each of the cells depending upon the criteria and hence field team can focus their optimization activity on the cells which are having major share of attempts. Load Shifting, Parameter Related changes, Azimuth and Tilt related optimization activities can be planned easily depending on the potential neighbor information.

As illustrated, in FIG. 3, a neighbor cell evaluation uses the calculated parameters and defined thresholds to evaluate each neighboring cell to determine its ranking. The system (100-2) compares the parameter values of each neighbor cell against the thresholds and assigns a ranking score or priority based on the compliance with the defined criteria. The system (100-2) also ranks the neighbor cells based on their evaluation scores or priorities. Cells that meet or exceed the threshold values for the defined parameters are assigned higher rankings. The system (100-2) may also consider additional factors such as network policies, load balancing requirements, or specific quality of service (QoS) criteria to further refine the ranking. Based on the rankings, the system (100-2) makes a handover decision, indicating the preferred high ranking neighbor cell for handover. The decision is communicated to the network management systems or mobile devices, which initiate the handover process to connect to the selected neighbor cell.

In an embodiment, the system (100-2) continuously monitors the performance of the selected neighbor cell after handover. It gathers feedback on signal quality, user experience, and network conditions to validate the accuracy of the handover decision. This feedback is used to refine the parameters, thresholds, and ranking algorithms in subsequent iterations. The system (100-2) is designed to adapt dynamically to changing network conditions. It continuously updates the measurements, recalculates the parameters, and adjusts the rankings based on real-time data. This ensures that the identification of higher-ranking neighbor cells remains accurate and responsive to the evolving network environment. By following this process flow, the system (100-2) can effectively identify higher ranking neighbor cells, enabling seamless handover and improving the overall performance and user experience in a telecommunications network.

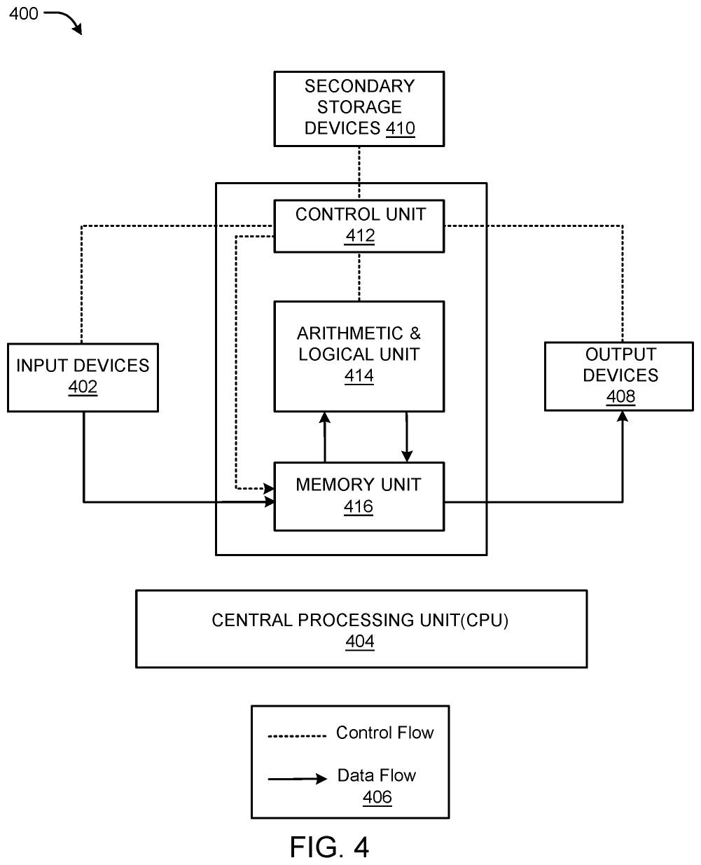

FIG. 4 illustrates an exemplary computer system (400) in which or with which embodiments of the present invention can be utilized, in accordance with an embodiment of present disclosure.

The computer system (400) includes input devices (402) connected through I/O peripherals. The system (400) also includes a Central Processing Unit (CPU) (404), and Output Devices (408), connected through the I/O peripherals. The CPU (404) is also attached to a memory unit (416) along with an Arithmetic and Logical Unit (ALU) (414), a control unit (412), along with secondary storage devices (410) such as Hard Disks and a Secure Digital Card (SD). The data flow and control flow (406) are indicated by a straight and dashed arrow respectively. The CPU consists of data registers that hold the data bits, pointers, cache, Random Access Memory (RAM) (204), and a main processing unit containing the processing engine (208). The system (400) also consists of communication buses that are used to transport the data internally in the system (400).

In an embodiment, a processor (202) of the system (100-2) is used to process all the data that is required for identification of a higher ranked neighbor cell. A person skilled in the art will appreciate that the system (100-2) may include more than one processor (202) and communication ports for ease of function. Examples of processors (202) include, but are not limited to, an Intel® Itanium® or Itanium 2 processor(s), or AMD® Opteron® or Athlon MP® processor(s), Motorola® lines of processors, FortiSOC™ system on a chip processor or other future processors. The processor (202) may include various modules associated with embodiments of the present invention. The input component can also include communication ports, ethernet ports, gigabit ports, parallel port, or another Universal Serial Bus (USB). The communication port can also be chosen depending on a specific network such as a Wide Area Server (WAN), Local Area Network LAN), or a Personal Area Network (PAN). The communication port can be a RS-232 port that can be used with the remote dialling and internet connection options of the system (400). A Gigabit port can be used to connect the system (400) to the internet at all times. And the Gigabit port can use copper or fibre for connection.

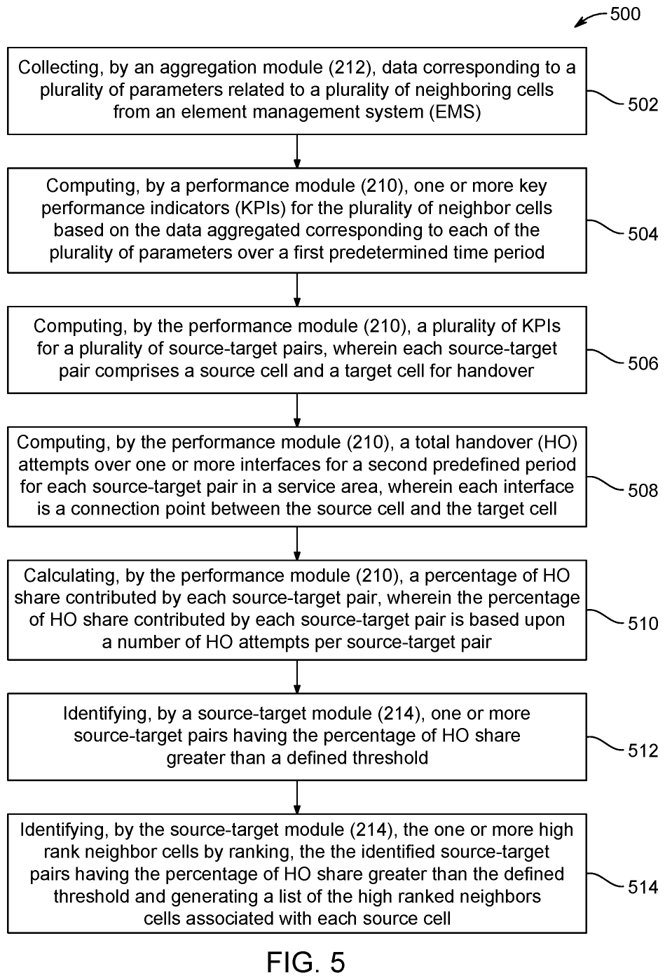

FIG. 5 illustrates exemplary steps of a method (500) identifying one or more high rank neighbor cells in a network, in accordance with embodiments of the present disclosure.

At step (502), an aggregation module collects the data corresponding to a plurality of parameters related to a plurality of neighboring cells from an element management system (EMS). In an example, the plurality of parameters comprises one or more of a signal strength, a signal quality, a plurality of interference levels, a data throughput, call drop rates, a latency, and a capacity of the neighboring cell.

At step (504), a performance module computes one or more key performance indicators (KPIs) for the plurality of neighbor cells based on the data aggregated corresponding to each of the plurality of parameters over a first predetermined time period. In an example, the first predefined time lies in a range of 15 to 30 minutes.

At step (506), the performance module computes a plurality of KPIs for a plurality of source-target pairs. Each source-target pair comprises a source cell and a target cell for handover. In an aspect, the plurality of KPIs include one or more of signal strength, signal quality, a plurality of interference levels, load balancing requirements, a coverage area, a capacity, and a plurality of operator-defined policies.

At step (508), the performance module computes a total handover (HO) attempts over one or more interfaces for a second predefined period for each source-target pair in a service area, wherein each interface is a connection point between the source cell and the target cell. In an example, the second predefined time lies in a range of one hour to two hours.

At step (510), the performance module calculates a percentage of HO share contributed by each source-target pair, wherein the percentage of HO share contributed by each source-target pair is based upon the number of HO attempts per source-target pair.

At step (512), a source-target module identifies one or more source-target pairs having the percentage of HO share greater than a defined threshold.

At step (514), the source-target module identifies the one or more high rank neighbor cells by ranking, the identified source-target pairs having the percentage of HO share greater than the defined threshold and generates a list of the high ranked neighbor cells associated with each source cell.

In an aspect, the percentage of HO share={100*[(total number of HO attempts per source-target pair)/(total number of HO attempts for all interfaces for the source cell)]}.

In an aspect, the method further includes a step of arranging, by the source-target module, the plurality of source-target pairs in a descending order based on the percentage HO share.

In an aspect, the method further includes a step of storing, by a database (218), the generated list of high ranked neighbor cells associated with each of the source cells.

In an aspect, the method further includes a step of analysing the one or more high ranked neighbor cells associated with each source cell to enable handover planning, cell compensation, and capacity planning.

In an exemplary aspect, the present disclosure discloses a user equipment which is configured to identify one or more high rank neighbor cells in a network. The user equipment includes a processor, and a computer readable storage medium storing programming instructions for execution by the processor. Under the programming instructions, the processor is configured to collect data corresponding to a plurality of parameters related to a plurality of neighboring cells from an element management system (EMS). Under the programming instructions, the processor is configured to compute one or more key performance indicators (KPIs) for the plurality of neighbor cells based on the data aggregated corresponding to each of the plurality of parameters over a first predetermined time period. Under the programming instructions, the processor is configured to compute a plurality of KPIs for a plurality of source-target pairs, wherein each source-target pair comprises a source cell and a target cell for handover. Under the programming instructions, the processor is configured to compute a total handover (HO) attempts over one or more interfaces for a second predefined period for each source-target pair in a service area, wherein each interface is a connection point between the source cell and the target cell. Under the programming instructions, the processor is configured to calculate a percentage of HO share contributed by each source-target pair, wherein the percentage of HO share contributed by each source-target pair is based upon a number of HO attempts per source-target pair. Under the programming instructions, the processor is configured to identify one or more source-target pairs having the percentage of HO share greater than a defined threshold. Under the programming instructions, the processor is configured to identify the one or more high rank neighbor cells by ranking, the identified source-target pairs having the percentage of HO share greater than the defined threshold and generate a list of the high ranked neighbor cells associated with each source cell.

It is to be appreciated by a person skilled in the art that while various embodiments of the present disclosure have been elaborated for identification of a higher ranked neighbor cell. However, the teachings of the present disclosure are also applicable for other types of applications as well, and all such embodiments are well within the scope of the present disclosure. However, the system (100-2) and method for sign language conversion is also equally implementable in other industries as well, and all such embodiments are well within the scope of the present disclosure without any limitation.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While considerable emphasis has been placed herein on the preferred embodiments it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present invention provides a system for efficiently executing an identification of highest-ranking neighbor cell.

The present invention provides a system that ensures that handovers occur to cells that provide superior performance to improve network performance in terms of call quality, data transfer rates, reduced call drops, and minimized latency.

The present invention provides a system that enables seamless handovers with minimal disruptions, leading to a more satisfactory and uninterrupted communication experience.

The present invention provides a system that facilitates load balancing by distributing traffic among neighboring cells, thereby reducing congestion on specific cells, and maximizing the overall network capacity.

The present invention provides a system that employs advanced algorithms and performance metrics to evaluate the performance of neighbor cells objectively.

The present invention provides a system that incorporates dynamic adaptation techniques, continuously monitoring and updating the performance rankings based on real-time network conditions.

The present invention provides a system that allows for quick adjustment to changes in signal strength, interference levels, and other performance indicators, ensuring the rankings remain up to date.

The present invention provides a system that can be customized to fit specific network requirements, including different technologies, deployment scenarios, and operator-defined policies.

The present invention provides a system that provides a clear ranking of neighbor cells, and assists in the handover decision-making process.

The present invention provides a system that provides informed decisions based on objective performance metrics, leading to more efficient and accurate handovers.

The present invention provides a system that helps minimize handover failures and unsuccessful handover attempts and reduces call drops and improves overall network reliability.

1. A method for identifying one or more high rank neighbor cells in a network, the method comprising:
collecting, by an aggregation module, data corresponding to a plurality of parameters related to a plurality of neighbor cells from an element management system (EMS);
computing, by a performance module, one or more key performance indicators (KPIs) for the plurality of neighbor cells based on the data aggregated corresponding to each of the plurality of parameters over a first predetermined time period;
computing, by the performance module, a plurality of KPIs for a plurality of source-target pairs, wherein each source-target pair comprises a source cell and a target cell for handover;
computing, by the performance module, a total handover (HO) attempts over one or more interfaces for a second predefined period for each source-target pair in a service area, wherein each interface is a connection point between the source cell and the target cell;
calculating, by the performance module, a percentage of HO share contributed by each source-target pair, wherein the percentage of HO share contributed by each source-target pair is based upon a number of HO attempts per source-target pair;
identifying, by a source-target module, one or more source-target pairs having the percentage of HO share greater than a defined threshold; and
identifying, by the source-target module, the one or more high rank neighbor cells by ranking the identified source-target pairs having the percentage of HO share greater than the defined threshold and generating a list of the high rank neighbor cells associated with each source cell.

2. The method as claimed in claim 1, wherein the percentage of HO share={100*[(total number of HO attempts per source-target pair)/(total number of HO attempts for all interfaces for the source cell)]}.

3. The method as claimed in claim 1, wherein the plurality of parameters comprises one or more of a signal strength, a signal quality, a plurality of interference levels, a data throughput, call drop rates, a latency, and a capacity of the neighbor cell.

4. The method as claimed in claim 1, wherein the first predetermined time period lies in a range of 15 to 30 minutes, and the second predefined time lies in a range of one hour to two hours.

5. The method as claimed in claim 1, further comprising arranging, by the source-target module, the plurality of source-target pairs in a descending order based on the percentage HO share.

6. The method as claimed in claim 1, wherein the plurality of KPIs include one or more of signal strength, signal quality, a plurality of interference levels, load balancing requirements, a coverage area, a capacity, and a plurality of operator-defined policies.

7. The method as claimed in claim 1, further comprising storing, by a database, the generated list of high rank neighbor cells associated with each of the source cells.

8. The method as claimed in claim 1, further comprising analysing the one or more high rank neighbor cells associated with each source cell to enable handover planning, cell compensation, and capacity planning.

9. A system for identifying one or more high rank neighbor cells in a network, the system comprising:
an aggregation module configured to collect data corresponding to a plurality of parameters related to a plurality of neighboring cells from an element management system (EMS);
a performance module configured to:
compute one or more key performance indicators (KPIs) for the plurality of neighbor cells based on the data aggregated corresponding to each of the plurality of parameters over a first predetermined time period;
compute a plurality of KPIs for a plurality of source-target pairs, wherein each source-target pair comprises a source cell and a target cell for handover;
compute a total handover (HO) attempts towards over one or more interfaces for a second predefined period for each source-target pair in the service area, wherein the interface is a connection point between the source cell and the target cell;
calculate a percentage of HO share contributed by each source-target pair, wherein the percentage of HO share contributed by each source-target pair is based upon a number of HO attempts per source-target pair; and
a source-target module configured to:
identify one or more source-target pairs having the percentage of HO share greater than a defined threshold; and
identify the one or more high rank neighbor cells by ranking the identified source-target pairs having the percentage of HO share greater than the defined threshold and generate a list of the high rank neighbor cells associated with each source cell.

10. The system as claimed in claim 9, wherein the percentage of HO share={100*[(total number of HO attempts per source-target pair)/(total number of HO attempts for all interfaces for the source cell)]}.

11. The system as claimed in claim 9, wherein the plurality of parameters comprises one or more of a signal strength, a signal quality, a plurality of interference levels, a data throughput, call drop rates, a latency, and a capacity of the neighbor cells.

12. The system as claimed in claim 9, wherein the first predetermined time period lies in a range of 15 to 30 minutes, and the second predefined time lies in a range of one hour to two hours.

13. The system as claimed in claim 9, wherein the source-target module is configured to rank the plurality of source-target pairs in a descending order on basis of the percentage HO share.

14. The system as claimed in claim 9, wherein the plurality of KPIs include one or more of signal strength, signal quality, a plurality of interference levels, load balancing requirements, a coverage area, a capacity, and a plurality of operator-defined policies.

15. The system as claimed in claim 9, includes a database configured to store the generated list of high rank neighbor cells associated with each of the source cells.

16. The system as claimed in claim 9, is further configured to analyse the one or more high rank neighbor cells associated with each source cell to enable handover planning, cell compensation, and capacity planning.

17. (canceled)

18. A computer program product comprising a non-transitory computer-readable medium comprising instructions that, when executed by one or more processors, cause the one or more processors to:
collect data corresponding to a plurality of parameters related to a plurality of neighbor cells from an element management system (EMS);
compute one or more key performance indicators (KPIs) for the plurality of neighbor cells based on the data aggregated corresponding to each of the plurality of parameters over a first predetermined time period;
compute a plurality of KPIs for a plurality of source-target pairs, wherein each source-target pair comprises a source cell and a target cell for handover;
compute a total handover (HO) attempts over one or more interfaces for a second predefined period for each source-target pair in a service area, wherein each interface is a connection point between the source cell and the target cell;
calculate a percentage of HO share contributed by each source-target pair, wherein the percentage of HO share contributed by each source-target pair is based upon a number of HO attempts per source-target pair;
identify one or more source-target pairs having the percentage of HO share greater than a defined threshold; and
identify the one or more high rank neighbor cells by ranking the identified source-target pairs having the percentage of HO share greater than the defined threshold and generate a list of the high rank neighbor cells associated with each source cell.
